(19) United States
(12) Patent Application Publication
(10) Pub. No.: US 2012/0092326 A1
(43) Pub. Date: Apr. 19, 2012

(54) Branded Location Referencing

(75) Inventors: Jason Borak, Lombard, IL (US); James Ronald Bennett, San Jose, CA (US)

(73) Assignee: NAVTEQ NORTH AMERICA, LLC, Chicago, IL (US)

(21) Appl. No.: 12/904,247

(22) Filed: Oct. 14, 2010

(51) Int. Cl. G09G 5/00; G09G 5/02; G06T 15/00

(52) U.S. Cl. 345/419; 345/641; 345/589

(57) ABSTRACT

A method and system for displaying a map that depicts landmarks with brand identity are disclosed. A map display application obtains the physical dimensions of a landmark, such as a building, and fills the footprint of the landmark with the brand identity of a company and/or a product associated with the landmark. The map display application can also render the landmark in 3D.

### FIELD

The present invention relates generally to map display, and more particularly, relates to a map display that depicts landmarks using brand identity.

### BACKGROUND

There are various computing platforms that graphically display maps of geographic areas. For example, some in-vehicle navigation systems include a display screen upon which a map of a geographic area can be displayed graphically. Maps can also be displayed on personal computers, mobile telephones, personal digital assistants, and other computing platforms.

In order to display the maps, these systems use geographic data. The geographic data may be in the form of one or more geographic databases that include data representing physical features in the geographic region. The geographic database includes information about the represented geographic features, such as position of the roads, speed limits along portions of roads, address ranges along the road portions, turn restrictions at intersections of roads, direction restrictions, such as one-way streets, and so on. Additionally, the geographic data may include points of interests, such as businesses, facilities, restaurants, hotels, airports, gas stations, stadiums, police stations, and so on.

These systems typically allow a user to search for locations in the map. For example, a user may enter an address and the system displays a map that identifies the location of the property associated with the address. As another example, the system may determine the user's current location using a position determining device, such as a GPS device, and display a map identifying the user's current position on the map. The map may also depict businesses and other points of interest around the user's current position or entered address.

When a user requests the location of a place to be depicted in a map, the system may identify the location on the map using a place marker. The place marker may be a dot, an arrow, a push pin symbol, or other identifier. For example, if the system knows the user's current position and the user requests information regarding the location of nearby gasoline stations, the system may display a map with push pin symbols identifying the user's position and the locations of gasoline stations nearby.

While this manner of displaying the location of points of interest on a map is useful, there is still room for improvements. For example, it would be beneficial to display a map that allows a user to easily identify the points of interests on a map without the user having to enter a business name and/or type.

### SUMMARY

A method and system for displaying a map that depicts landmarks using brand identity are disclosed. The method includes retrieving landmark data from a database, such as landmark dimensions, brand information, and display information. The brand information includes at least a background color and a brand logo. The method also includes rendering an image of the landmark by filling the landmark dimensions with the background color and overlaying the brand logo over the background color. Further, the method includes displaying the image of the landmark on a map display using the display information.

The system includes a representation of landmarks located in a geographic region. The representation identifies whether the landmarks are associated with a brand. For each landmark associated with a brand, the representation includes data that identifies footprint dimensions and brand identity. A map display application uses the footprint dimension data and the brand identity data to depict the landmarks using brand identity in a map display.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a block diagram of a computing platform for map display, according to an example;

FIG. 2 is a block diagram of some data attributes of a geographic database depicted in FIG. 1, according to an example;

FIG. 3 is a flow diagram of a method of map display, according to an example;

FIG. 4 depicts a 2D map display, according to an example; and

FIG. 5 depicts a 3D map display, according to an example.

### DETAILED DESCRIPTION

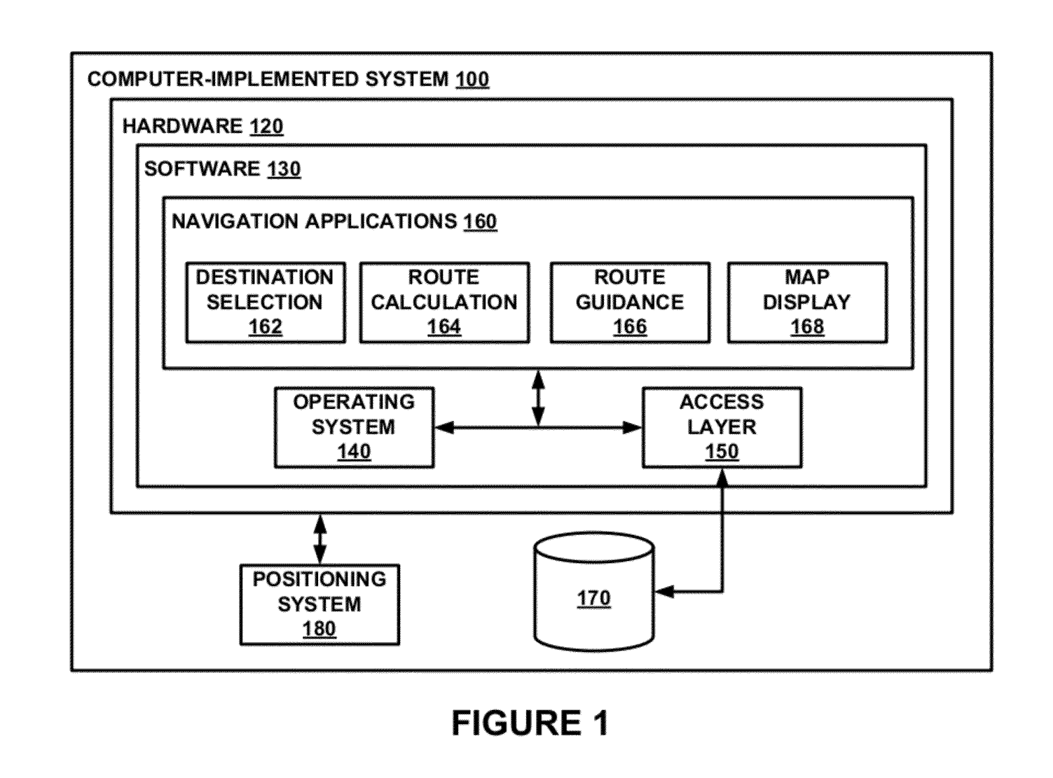

FIG. 1 shows a system 100 for providing geographic and navigation-related information to users. The system 100 may be a proprietary system or a general-purpose system. Alternatively, some parts of the system may be proprietary and other parts may be general purpose. The system 100 may be a standalone system or a networked or distributed system. The system 100 may be portable, e.g., a notebook computer, a mobile telephone, an in-vehicle navigation system, etc., or non-portable, e.g., a desktop computer system.

The system 100 is a combination of computer hardware 120, software 130, and data. The computer hardware 120 includes memory, processor(s), data storage, and other components. The software 130 includes an operating system 140, data access software 150 for accessing the data, and navigation and/or map related applications 160, which use the geographic data to provide meaningful information to users of the system 100. The software 130 may include other applications as well.

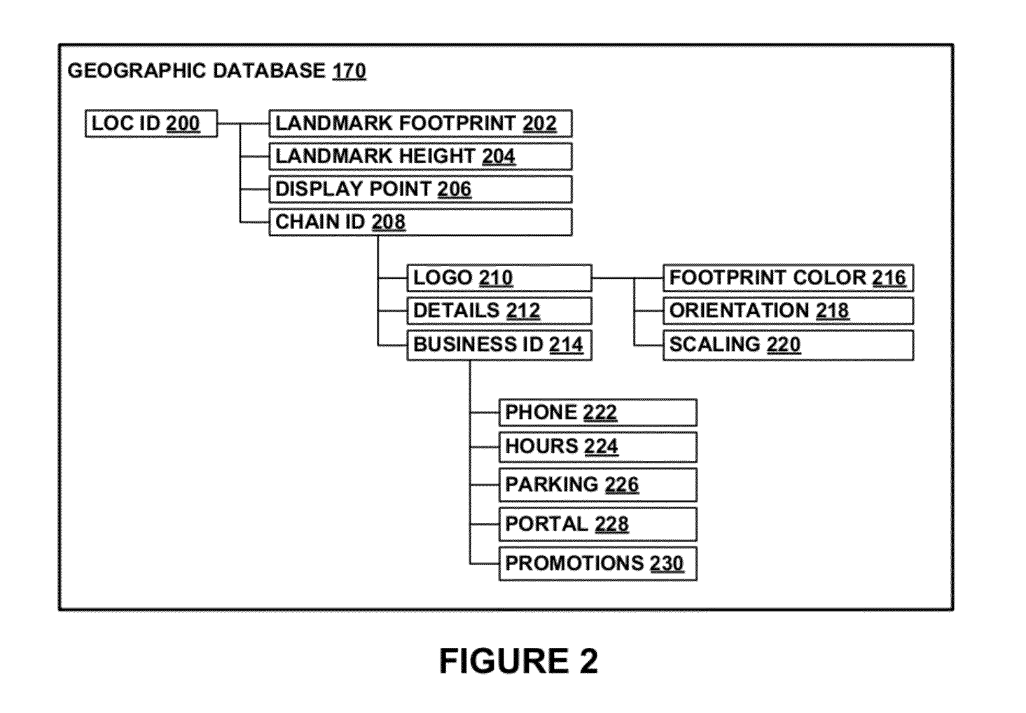

Associated with the system 100 is a geographic database 170. The geographic database 170 may be located within the system 100 as depicted in FIG. 1 or may be located remotely from the system 100. If the geographic database 170 is located remotely from the system 100, the data in the geographic database 170 may be provided to the system 100 via a network or other type of communications system. The network or other type of communications system may be wireless, land-based, or a combination of both wireless and land-based. The network may include the Internet. The geographic database 170 is further described with reference to FIG. 2.

The system 100 may also include a positioning system 180. The positioning system 180 may utilize Global Positioning System (GPS) technology, a dead reckoning technology, or other position determining technology now known or developed in the future. The positioning system 180 may include sensors that measure distance, speed, direction, orientation, and so on. The navigation applications 160 may use data from the positioning system 180.

The system 100 includes an appropriate user interface (not shown), which includes hardware and software that allows a user to input information into the system 100 and receive information from the system 100. The user interface may include a monitor, keyboard, keypad, touch screen, speakers, microphone, and so on. The input information may include a request for map display and/or route guidance. The output information may include a map displayed on the monitor.

Among the navigation applications 160 are a destination selection application 162, a route calculation application 164, a route guidance application 166, and a map display application 168. These may be separate applications or these applications may be combined into a single application that includes all of the functions. The navigation applications 160 may be written in a suitable computer programming language, such as C, C++, or Java.

The destination selection application 162 accepts a user's specification of information for identifying one or more possible places to be used as a destination. The information may be an address, the name of a business (e.g., Macy's, Mobil), a type of business (e.g., department store, gasoline station), a type of product (e.g., clothing, gasoline), and so on. The destination selection application 162 uses the geographic database 170 to find possible destinations that match the search criteria.

Upon finding one or more potential matches for a user's search request, the destination selection application 162 provides the results to the end user. The destination selection application 162 may provide the user with various details about each of the potential matches, such as a location of each potential destination, a distance from the user's position to the potential destination, a description of the location, a phone number, hours of operation, promotions, etc.

The route calculation application 164 calculates a route from the user's current position or an entered starting point to a destination. The route calculation application 164 uses the data in the geographic database 170 for this purpose. As part of determining the route, the route calculation application 164 calculates a distance of the route by adding the distances of road segments that comprise the route from the starting point to the desired destination. The route calculation application 164 then forwards data representing the route to the route guidance application 166. The route guidance application 166 generates appropriate directions, such as maneuvering instructions, for the user to follow the route.

The route calculation application 164 and/or the route guidance application 166 may also forward data representing the route to the map display application 168, which renders and displays the route and/or the guidance on the system's monitor. Additionally or alternatively, the map display application 168 may directly access data from the geographic database 170 for generating and rendering a map of the geographic area around the user's current position or requested location.

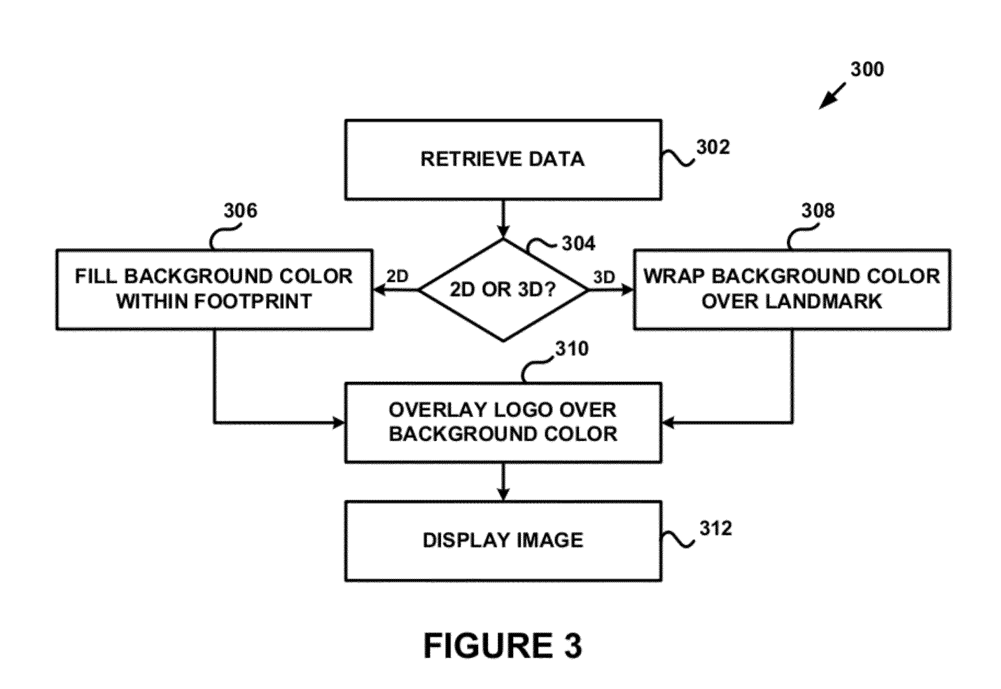

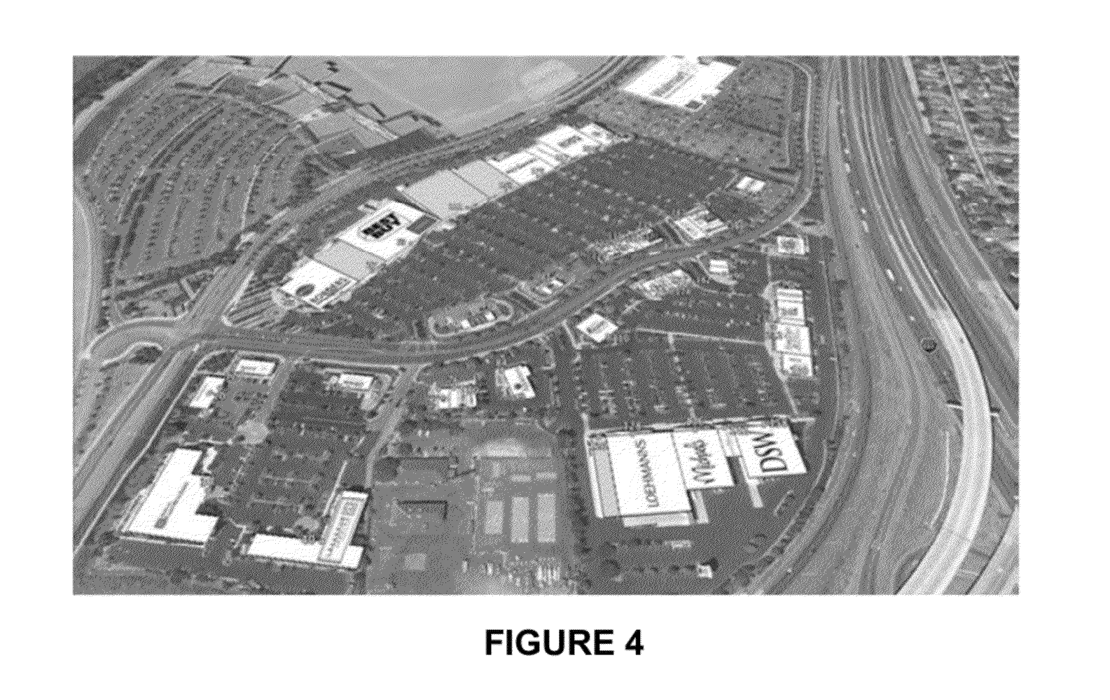

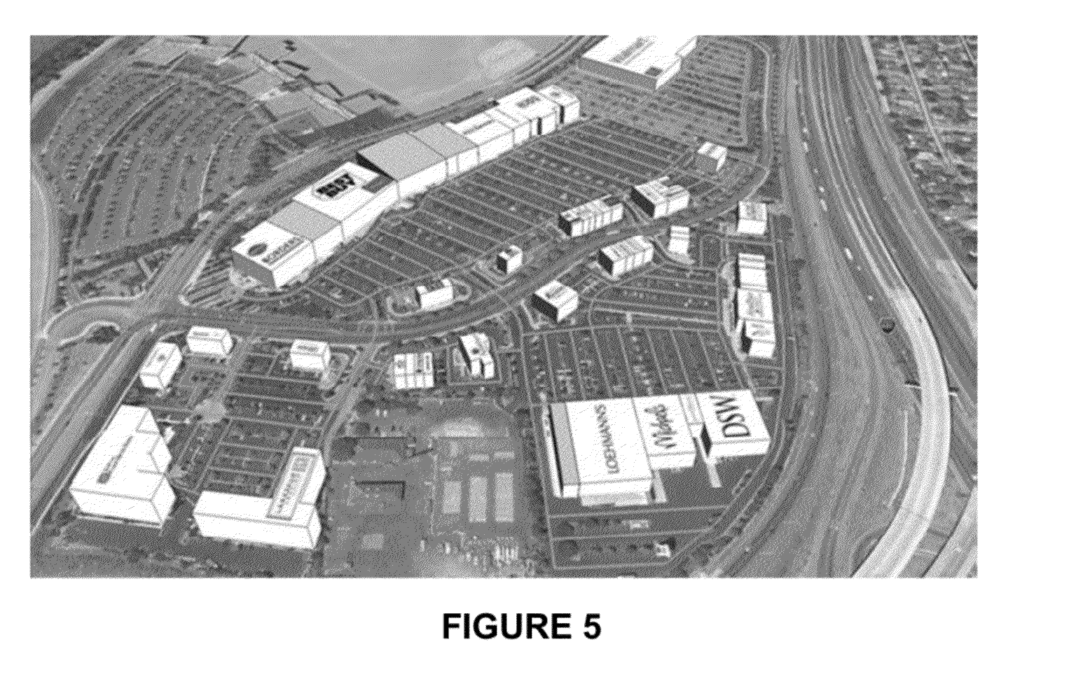

The image rendered by the map display application 168 may show the roads located in the vicinity of the user. The image may also show landmarks in the geographic area. A landmark is any type of facility that occupies a geographic area. While the landmarks depicted in FIGS. 4-5 are buildings, a landmark can be another type of facility. When the landmark is associated with a brand, the brand may be used in the image to aid in the identification of the landmark. A brand is an identity of a specific product, service, or business. The brand can take many forms, including a trade or service mark, a name, a sign, a symbol, a color combination, and/or a slogan. The map display application 168 is further described with reference to FIGS. 3-5.

The geographic database 170 may include a basic portion and an extended portion. The basic portion of the geographic database 170 includes the kind of data included in typical geographic databases. The basic portion includes information about the roads, such as the locations of the roads, the locations of intersections, road names, address ranges, speed limits, turn restrictions, one-way street information, number of lanes, and so on. The basic portion may also include information about points of interest such as businesses (e.g., hotels, restaurants, shopping, service stations, etc.), government buildings, police stations, hospitals, recreation areas, and so on.

The geographic database 170 also includes an extended portion. The extended portion includes data attributes that may be used to provide a visual representation of a landmark using brand identity. An example of some of the data attributes that may be stored in extended portion is shown in FIG. 2.

A location identifier 200 is assigned to each landmark for which brand identity may be used to provide a visual representation of the landmark. Not all landmarks have an associated brand identity. The location identifier 200 may be a numeric code, an alpha-numeric code, or any other string of numbers, letters, and/or symbols that can be used to identify a landmark.

Preferably, the brand identity is a company's logo and/or trade or service mark. However, the brand owner or other entity may select another manner in which to identify its locations. The visual representation consists of filling the brand identity within the footprint of a landmark in a 2D visual representation as seen in FIG. 4 or draping the brand identity over the 3D representation of a landmark in a 3D visual representation as seen in FIG. 5.

The location identifier 200 may be associated with data attributes regarding landmark footprint 202, landmark height 204, a display point 206, and a chain identifier 208. The location identifier 200 may be associated with other data attributes as well. The landmark footprint attribute 202 includes polygon data representing the shape and orientation of the ground level of the landmark. The landmark height attribute 204 includes height data that represents the height of the landmark. The map display application 168 uses the landmark footprint attribute 202 to render either a 2D or a 3D landmark image. To render a 3D landmark image, the map display application 168 also uses the landmark height attribute 204.

The display point attribute 206 includes location data (e.g., latitude and longitude) for a display point. The map display application 168 uses the display point attribute 206 for displaying a landmark location on a map display. Usually, the location data for the display point attribute 206 identifies a nominal center of a polygonal area defining the landmark footprint. However, if the landmark has an unusual shape, the location data for the display point attribute 206 may identify another appropriate point associated with the landmark.

The chain identifier 208 includes a code assigned to a business chain. The business chain could be a restaurant chain (e.g., McDonalds, Burger King, Applebee's), a hotel chain (e.g., Holiday Inn, Hilton, Best Western), a gasoline chain (Shell, Mobil, BP), and so on. The code may be a numeric code, an alpha-numeric code, or any other string of numbers, letters, and/or symbols that can be used to identify a chain.

The chain identifier 208 is associated with a logo attribute 210. The logo attribute 210 contains a brand icon file. Alternatively, the logo attribute 210 includes a reference to a memory location where the brand icon file is stored. The brand icon file includes an image of the logo/brand to be used during map display. The brand icon file may be in the Portable Network Graphics format (i.e., .png). However, other file formats, such as JPEG and GIF, may be used.

The logo attribute 210 is associated with a footprint color attribute 216, an orientation attribute 218, and a scaling attribute 220. The logo attribute 210 may also be associated with other attributes, such as footprint patterns, border styles (e.g., different colors and/or patterns to indicate a status of a landmark), and so on. The map display application 168 uses the footprint color attribute 216 to select a background color for filling in the footprint of a landmark in a 2D visual representation and draping over the 3D model of a landmark in a 3D visual representation. The map display application 168 overlays the brand icon file over the background color.

The orientation attribute 218 identifies what direction the brand icon file faces when overlaid on the background color. The direction may be chosen based on the size and the shape of the landmark footprint. Additionally or alternatively, the direction may be chosen based on the location of nearby streets and other features in the geographic area. The orientation attribute 218 may include more than one direction so that a direction can be selected based on the orientation of the map as it is displayed to a user.

The scaling attribute 220 identifies one or more icon sizes for overlaying the icon on the footprint. The map display application 168 may resize the icon image based on zoom level. Additionally, the map display application 168 may use the scaling attribute 220 to determine what level of icon detail to display. For example, if the user has zoomed in to show a small portion of a geographic region, the icon may be displayed with more details than if the user has zoomed out to show a larger portion of the geographic region.

The chain identifier 208 is also associated with a detail attribute 212. The detail attribute 212 includes data regarding details of the chain. For example, the details may include the chain type, chain policies, corporate contact information, and so on.

The chain identifier 208 is also associated with a business identifier 214. The business identifier 214 includes a code that represents a particular business within a chain. For example, MAC23RI may represent the 23^{rd} McDonald's restaurant location opened in Rhode Island. The code may be a numeric code, an alpha-numeric code, or any other string of numbers, letters, and symbols that can be used to identify a business.

The business identifier 214 is associated with other attributes that include data representing characteristics of the business associated with the business identifier 214. As shown in FIG. 2, these attributes include a phone attribute 222, an hours attribute 224, a parking attribute 226, a portal attribute 228, and a promotions attribute 230. Other attributes may also be used to characterize business operations.

FIG. 3 is a flow diagram of a method 300 for displaying a map that depicts landmarks using brand identity. Generally, the method 300 includes retrieving the appropriate data, rendering the data into a map image, and displaying the map image. Rendering is the process of generating an image from a model using a computer program. Here, the map display application 168 renders the map images. The map display application 168 may use any rendering technique. For example, the map display application 168 may use the rendering technique described in U.S. Pat. No. 6,092,076, which is assigned to the same assignee as the current application. U.S. Pat. No. 6,092,076 is hereby incorporated by reference.

At block 302, the map display application 168 retrieves data from the geographic database 170. The map display application 168 may also obtain data from the other navigation applications 160 and/or the positioning system 180. Based on the user's current position or requested location, the map display application 168 retrieves data for a particular geographic area from the geographic database 170.

Within the geographic area, the map display application 168 identifies landmarks for which brand identity is available using the location identifier 200. For each of the landmarks for which brand identity is available, the map display application 168 retrieves data that identifies how to display the brand identity, including data stored in the landmark footprint attribute 202, the landmark height attribute 204, the display point 206, and data associated with the chain identifier attribute 208.

At block 304, the map display application 168 determines whether each of the identified landmarks includes height data. If height data is available for a landmark, the map display application 168 may display the landmark in 3D. However, if height data is not available for the landmark, the map display application 168 displays a 2D depiction of the landmark. Even if the height data is available for the landmark, the map display application 168 may display a map using 2D depictions based on user preference/selection, the type of system 100 being used, or for any other reason.

At block 306, if the map display application 168 determines to display a 2D version of the brand identity, the map display application 168 uses the previously retrieved landmark footprint data and footprint color data to fill the background color within the 2D boundaries of the landmark. At block 308, if the map display application 168 determines to display a 3D version of the brand identity, the map display application 168 uses the previously retrieved landmark footprint data, landmark height data, and footprint color data to drape the background color over the 3D shape of the landmark.

At block 310, the map display application 168 overlays the previously retrieved brand icon file over the background color. The map display application 168 uses the previously retrieved display point data, orientation data, and scaling data to determine how to overlay the brand icon file on the background color.

Once the map display application 168 has completed the processing steps for each landmark to be displayed, the map display application 168 displays a map image at block 312. FIG. 4 depicts a 2D map display and FIG. 5 depicts a 3D map display of the same geographic area. As shown in FIGS. 4 and 5, not all of the landmarks in a geographic area are associated with a brand identity. For those landmarks that are associated with a brand identity, FIGS. 4 and 5 depict that the brand icon images may have different display points, different orientation, and different scaling.

Because FIGS. 4 and 5 are black and white drawings, they do not show that the footprint colors can vary from landmark to landmark. For example, the DSW store may have a white DSW brand icon image overlaying a brown footprint color, while the Michael's store may have a red MICHAEL's brand icon image overlaying a white footprint color. The footprint color may also indicate that a store is out of business, a store is currently closed and/or open, a store is opening soon, merchant coupons are available, and/or other landmark status information. Additionally or alternatively, a border of a footprint may have a particular color or pattern to indicate a status of a landmark.

In addition to brand identities for a landmark, the map display application 168 may display brand identities for merchandise available at the landmark, with or without the landmark's brand identity. For example, if Nike shoes are available at the DSW store, the map display application 168 may display the Nike logo icon on the DSW footprint, with or without the DSW logo icon. As another example, the map display application 168 may display dynamic information, such as movie times on the footprint of a movie theater. As yet another example, the map display application 168 may overlay an advertisement on a landmark.

A user of the system 100 may personalize how the map display application 168 functions. For example, the user may select the brands and/or products to display. The user may also select whether or not advertisements are provided in the display and, if so, how the advertisements are displayed. For example, the map display application 168 may use colors, patterns, and icons to indicate that advertising information is available to the user.

As a user views a map display depicting brand identity, the users can easily grasp where landmarks are located with respect to other landmarks in the geographic region. Moreover, landmark colors and patterns can be used by the viewer to easily identify whether a business is currently open or closed, opening soon for business, closed for business, what products/services are available at the business, and/or whether the business is offering any promotions. This is a much more effective method of displaying relevant information than the push pin graphics.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A computer-implemented method for displaying a map that depicts landmarks using brand identity, comprising:
receiving a request for a map display, wherein the request includes information regarding a landmark;
retrieving data from a database that includes data representing a brand identity associated with the landmark; and
providing a map display that identifies the landmark by overlaying the brand identity over a footprint model of the landmark.

2. The method of claim 1, wherein the request includes at least one of an address, a business name, and a business type.

3. The method of claim 1, wherein the database includes polygon data representing a ground level boundary of the landmark.

4. The method of claim 3, wherein the brand identity fills the boundary represented by the polygon data.

5. The method of claim 3, wherein the database further includes height data representing a height of the landmark.

6. The method of claim 5, wherein the brand identity overlays a 3D space represented by the polygon data and the height data.

7. The method of claim 1, wherein the brand identity includes brand image overlaying a footprint color.

8. The method of claim 7, wherein the brand image is associated with a business located at the landmark.

9. The method of claim 7, wherein the brand image is associated with merchandise or services available at the landmark.

10. The method of claim 7, wherein the footprint color represents a status of the landmark.

11. The method of claim 10, wherein the status is at least one of open for business, closed for business, out of business, business is coming soon, and promotion information is available.

12. A geographic database system, comprising:
a representation of a road network in a geographic region; and
a representation of landmarks located in the geographic region that identifies whether the landmarks are associated with a brand, wherein for each of the landmarks associated with a brand, the representation includes data that identifies footprint dimensions including height and brand identity so that a map display application depicts the landmarks associated with a brand using the brand identity bounded by the footprint dimensions.

13. The system of claim 12, wherein the map display application depicts the landmarks in 3D.

14. The system of claim 12, wherein the brand identity includes a brand icon overlaying a background color.

15. The system of claim 14, wherein the brand icon is associated with a business located at the landmark.

16. The system of claim 14, wherein the brand icon is associated with merchandise or services available at the landmark.

17. The system of claim 16, wherein the brand icon is associated with dynamic information associated with the merchandise or services available at the landmark.

18. A method for displaying a map that depicts landmarks using brand identity, comprising:
retrieving landmark data from a database, wherein the data includes three dimensional landmark dimensions, brand information, and display information, wherein the brand information includes at least a background color and a brand icon;
rendering an image of the landmark by filling the landmark dimensions with the background color and overlaying the brand icon over the background color; and
displaying the image of the landmark on a map display using the display information.

19. The method of claim 18, wherein the image of the landmark is a 3D image.

20. The method of claim 18, wherein in the display information includes at least one of display point, orientation, and scaling.
